(19) United States
(12) Patent Application Publication
(10) Pub. No.: US 2026/0120572 A1
(43) Pub. Date: Apr. 30, 2026

(54) DETECTING POTENTIAL CRASHES AND UNSAFE CONDITIONS

(71) Applicant: Texas State University, San Marcos, TX (US)

(72) Inventors: Subasish Das, San Marcos, TX (US); Rohit Chakraborty, San Marcos, TX (US)

(21) Appl. No.: 19/344,903

(22) Filed: Sep. 30, 2025

Related U.S. Application Data
(60) Provisional application No. 63/714,064, filed on Oct. 30, 2024.

(51) Int. Cl. G08G 1/16; G06V 10/80; G06V 10/82; G06V 20/54; G08G 1/01

(52) U.S. Cl. CPC G08G 1/166; G06V 10/803; G06V 10/82; G06V 20/54; G08G 1/0116; G08G 1/0133; G08G 1/0141; G08G 1/0145; G08G 1/164; G06V 2201/08

(57) ABSTRACT

A computer-implemented method, system, and computer program product for detecting crashes and unsafe conditions. Real-time data on vehicle movements and road users are captured. The captured real-time data is processed to detect and track vehicle and road user movements. Based on the processed real-time data, trajectories of the vehicle and road user movements are predicted. Such predicted trajectories are analyzed, where a risk assessment for each detected vehicle movement and road user movement is conducted based on such analysis. A potential crash or unsafe condition is then identified in response to the risk assessment for a detected vehicle movement or road user movement exceeding a threshold value. Upon identifying a potential crash or unsafe condition, a warning message or alert of an impending crash or unsafe condition is generated. Such a warning message or alert is transmitted to the drivers and/or vulnerable road users so as to prevent a collision.

### TECHNICAL FIELD

The present disclosure relates generally to road hazard identification techniques, and more particularly to detecting potential crashes and unsafe conditions so as to prevent collisions by warning drivers and/or vulnerable road users of such potential crashes and unsafe conditions.

### BACKGROUND

According to the National Highway Traffic Safety Administration (NHTSA), the United States of America (“U.S.”) fatality rate for the first nine months of 2021 was 1.36 fatalities/100 million vehicle miles traveled. NHTSA also indicated that in the U.S., there were 38,680 motor vehicle related fatalities in 2020, a 7.2% increase from 2019 (36,096 motor vehicle related fatalities). The World Health Organization estimated that on a global basis, the number of traffic related deaths reached 1.35 million in 2016.

In recent years, a variety of road safety technologies have been developed to decrease road related crashes/injuries/deaths, traffic congestion, and infrastructure damage. Technologies in commercial use/under development range from manual procedures to automated/cloud-based/AI solutions including: (1) manual classification/inventorying techniques, (2) connected autonomous vehicle technologies, (3) smart traffic light/traffic control management systems, (4) over height vehicle detection systems including use of infrared (IR) beam or laser beam technologies; (5) wrong way driver/lane correction technologies; and (6) roadside slope monitoring technologies.

Unfortunately, such technologies are deficient in terms of preventing collisions, such as between automobiles, and/or vulnerable road users (those unprotected by an outside shield, such as pedestrians, cyclists, motorcyclists, people with disabilities or reduced mobility, horse riders, e-scooter riders, skateboarders, etc.).

### SUMMARY

In one embodiment of the present disclosure, a computer-implemented method for detecting potential crashes and unsafe conditions comprises processing captured real-time data on vehicle movements and road users to detect and track vehicle and road user movements. The method further comprises predicting trajectories of the vehicle and road user movements based on the processed real-time data. The method additionally comprises analyzing the predicted trajectories of the vehicle and road user movements. Furthermore, the method comprises conducting a risk assessment for each detected vehicle movement and road user movement based on the analysis of the predicted trajectories of the vehicle and road user movements. Additionally, the method comprises identifying a potential crash or an unsafe condition in response to the risk assessment for a detected vehicle movement or a road user movement exceeding a threshold value. In addition, the method comprises generating a warning message or alert of an impending potential crash or unsafe condition in response to identifying the potential crash or the unsafe condition.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 is a diagram of the software components used by the computer to detect potential crashes and unsafe conditions in accordance with an embodiment of the present disclosure;

FIG. 3 illustrates trajectory prediction using continual learning in accordance with an embodiment of the present disclosure;

FIG. 4 is a flowchart of a method for detecting potential crashes and unsafe conditions in accordance with an embodiment of the present disclosure;

FIG. 5 is a flowchart of a method for pedestrian distraction detection in accordance with an embodiment of the present disclosure; and

FIG. 6 illustrates the beacon layout in accordance with an embodiment of the present disclosure.

### DETAILED DESCRIPTION

As stated above, according to the National Highway Traffic Safety Administration (NHTSA), the United States of America (“U.S.”) fatality rate for the first nine months of 2021 was 1.36 fatalities/100 million vehicle miles traveled. NHTSA also indicated that in the U.S., there were 38,680 motor vehicle related fatalities in 2020, a 7.2% increase from 2019 (36,096 motor vehicle related fatalities). The World Health Organization estimated that on a global basis, the number of traffic related deaths reached 1.35 million in 2016.

In recent years, a variety of road safety technologies have been developed to decrease road related crashes/injuries/deaths, traffic congestion, and infrastructure damage. Technologies in commercial use/under development range from manual procedures to automated/cloud-based/AI solutions including: (1) manual classification/inventorying techniques, (2) connected autonomous vehicle technologies, (3) smart traffic light/traffic control management systems, (4) over height vehicle detection systems including use of infrared (IR) beam or laser beam technologies; (5) wrong way driver/lane correction technologies; and (6) roadside slope monitoring technologies.

Unfortunately, such technologies are deficient in terms of preventing collisions, such as between automobiles, and/or vulnerable road users (those unprotected by an outside shield, such as pedestrians, cyclists, motorcyclists, people with disabilities or reduced mobility, horse riders, e-scooter riders, skateboarders, etc.).

The embodiments of the present disclosure provide a means for preventing collisions, such as between automobiles, between an automobile and a vulnerable road user and/or between vulnerable road users. In one embodiment, real-time data on vehicle movements and road users are captured, such as from high resolution cameras placed at road intersections. The captured real-time data is then processed to detect and track vehicle and road user movements. In one embodiment, such captured real-time data is processed using data fusion and long short-term memory techniques. In another embodiment, such captured real-time data is processed using computer vision and machine learning algorithms. Based on the processed real-time data, trajectories of the vehicle and road user movements are predicted. Such predicted trajectories are then analyzed, where a risk assessment for each detected vehicle movement and road user movement is conducted based on such analysis. A potential crash or unsafe condition is then identified in response to the risk assessment for a detected vehicle movement or a road user movement exceeding a threshold value. Upon identifying a potential crash or unsafe condition, a warning message or alert of an impending crash or unsafe condition is generated. Such a warning message or alert is transmitted to the drivers and/or vulnerable road users so as to prevent a collision. A further discussion regarding these and other features is provided below.

Modern control systems, particularly emerging advanced intersection control systems, increasingly depend on real-time, data-driven decision-making to boost safety and efficiency. This need is particularly acute in safety-critical situations where human response times may fall short or lack comprehensive situational awareness. To address this, there is a growing demand for systems that can anticipate, prevent, and mitigate unsafe conditions at intersections, especially for vulnerable road users, such as pedestrians, cyclists, and users of micro-mobility devices. The Big Data Leveraged Intersection Safety System (BLISS) framework incorporates an anticipatory warning system and other safety countermeasures designed to meet the needs of both drivers and vulnerable road users (VRUs). This Intersection Safety System (ISS) prototype emphasizes cost-effectiveness to facilitate widespread deployment across high-risk intersections nationwide. Beyond technical advancements, BLISS considers commercial viability, mass-production feasibility, and the requirements and constraints of industry stakeholders and Infrastructure Owners and Operators (IOOs).

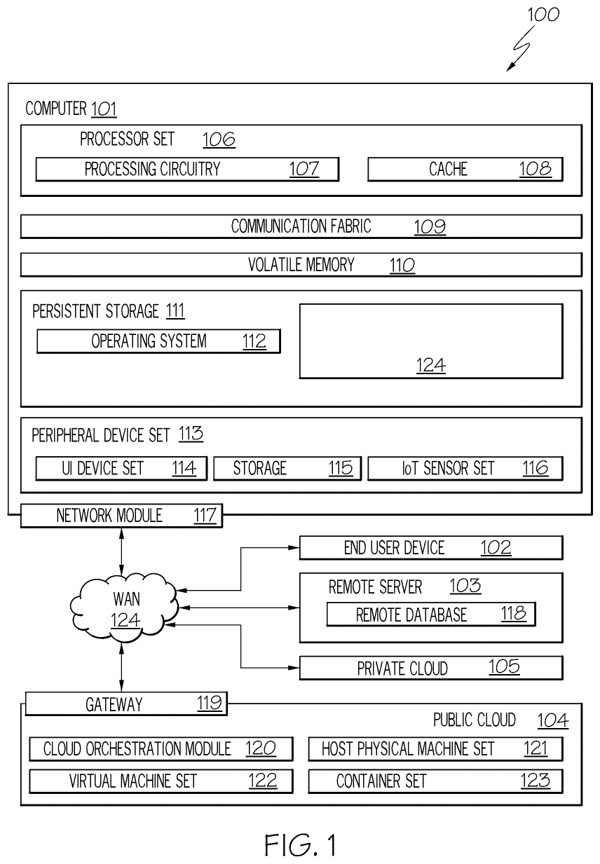

Thus, this tool can contribute to the creation of an efficient, equitable, and scalable ISS that significantly improves intersection safety. The framework of BLISS is described below. In particular, in one embodiment, the framework of BLISS is implemented in the computing environment discussed below in connection with FIG. 1.

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as detecting potential crashes and unsafe conditions. In addition to block 125, computing environment 100 includes, for example, computer 101, network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

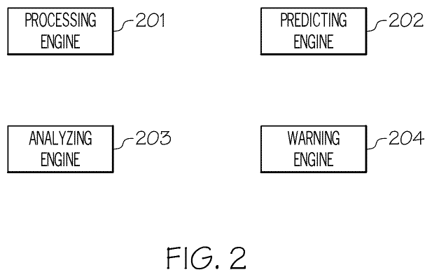

Block 125 further includes the software components discussed herein in connection with FIGS. 2-6 to detect potential crashes and unsafe conditions. In one embodiment, such components may be implemented in hardware. The functions discussed herein performed by such components are not generic computer functions. As a result, computer 101 is a particular machine that is the result of implementing specific, non-generic computer functions.

In one embodiment, the functionality of such software components of computer 101, including the functionality for detecting potential crashes and unsafe conditions, may be embodied in an application specific integrated circuit.

A further discussion regarding the functionality of the components used by computer 101 to detect potential crashes and unsafe conditions is provided below in connection with FIG. 2.

FIG. 2 is a diagram of the software components used by computer 101 to detect potential crashes and unsafe conditions in accordance with an embodiment of the present disclosure.

Referring to FIG. 2, in conjunction with FIG. 1, computer 101 includes processing engine 201 configured to process captured real-time data on vehicle movements and road users. In one embodiment, the captured real-time data is processed to detect and track vehicle and road user movements.

In one embodiment, such real-time data is captured using high-resolution cameras/video systems, LiDAR, radar, and various other sensor technologies at key locations within targeted intersections. An intersection, as used herein, refers to the location where two or more roadways meet, cross, or join, forming a general area that includes the roadway and surrounding facilities to manage traffic movements.

LiDAR (Light Detection and Ranging) is a remote sensing method that uses pulsed laser light to measure precise distances to objects, creating a detailed 3D map of an area, known as a “point cloud.” It works by emitting laser pulses and measuring the time it takes for the light to return after bouncing off surfaces, allowing for high-precision mapping of both natural and man-made environments. LiDAR creates highly detailed 3D representations, accurately measuring distance, velocity, and object size, while also distinguishing between closely spaced or slow-moving objects. It is capable of monitoring multiple objects simultaneously.

Radar excels in long-range detection, with an extended range that surpasses other sensor types. It accurately gauges vehicle speed and position without frequent calibration and preserves privacy by not capturing identifiable images of road users. Additionally, Radar performs well in adverse weather conditions, offering cost-effective solutions, and can detect pedestrians at significant distances.

Camera/Video systems can provide a rich level of detail, allowing differentiation among various road users. These systems benefit from widespread usage and established technology solutions, delivering superior object classification performance and angular resolution. They offer coverage for larger areas, accommodate unpredictable pedestrian movements, and provide valuable raw video data for safety assessments. Camera/Video systems can be seamlessly integrated with signal detection equipment, often require simplified calibration, and can be adapted for various use crashes.

In one embodiment, high-resolution cameras are utilized within an intersection to capture real-time data on vehicle movements and road users. In one embodiment, at least two cameras are installed to provide a comprehensive 360-degree view of the intersection. These cameras will operate continuously, capturing real-time data on the movements of vehicles and road users, offering a dynamic and detailed perspective of the intersection's activities. To ensure data accuracy, the raw information collected by the sensors will undergo a meticulous preprocessing stage performed by processing engine 201, aimed at filtering out noise and enhancing overall precision. Furthermore, in one embodiment, processing engine 201 implements data fusion techniques, integrating contextual information, such as speed limits, road infrastructure features (sidewalks, bike lanes, shoulders), and facility types. This integration approach will enable a more holistic understanding of the intersection's environment.

In one embodiment, processing engine 201 processes the captured real-time data using data fusion and long short-term memory techniques.

In one embodiment, processing engine 201 processes the captured real-time data using computer vision and machine learning algorithms.

Computing system 100 further includes prediction engine 202 configured to predict trajectories of the vehicle and road user movements.

In one embodiment, prediction engine 202 utilizes algorithms tasked with detecting and tracking vehicles and road users enabling prediction engine 202 to predict their trajectories. These predictions will be based on a combination of historical movement patterns, real-time data, and contextual information.

Computing system 100 additionally includes analyzing engine 203 configured to analyze the predicted trajectories of the vehicle and road user movements based on the processed real-time data. In one embodiment, the analysis of the predicted trajectories of the vehicle and road user movements includes analyzing vehicular speed, pedestrian walking pace and walking patterns, turning maneuvers, and turning intentions.

In one embodiment, in real-time, analyzing engine 203 performs dynamic analyses of the trajectories it detects, actively identifying potential conflicts or unsafe conditions. This analysis will consider various scenarios, accommodating both road users who adhere to intersection control signals and those who deviate from prescribed rules. Moreover, the trajectory prediction process will encompass a range of critical factors, including the speed of vehicles, the walking pace of pedestrians, pedestrian walking patterns, recognition of turning maneuvers, and the determination of turning intentions. Drawing from this comprehensive trajectory prediction, the system will generate numeric measures, such as gap analysis, potential conflict assessment, and time-to-crash calculations.

In one embodiment, analyzing engine 203 conducts a risk assessment for each detected vehicle movement and road user movement based on the analysis of the predicted trajectories of the vehicle and road user movements.

To identify potential crashes or unsafe conditions, in one embodiment, analyzing engine 203 conducts a thorough risk assessment for each detected movement. This assessment will encompass scenarios where road users strictly adhere to intersection control directions as well as situations where deviations occur.

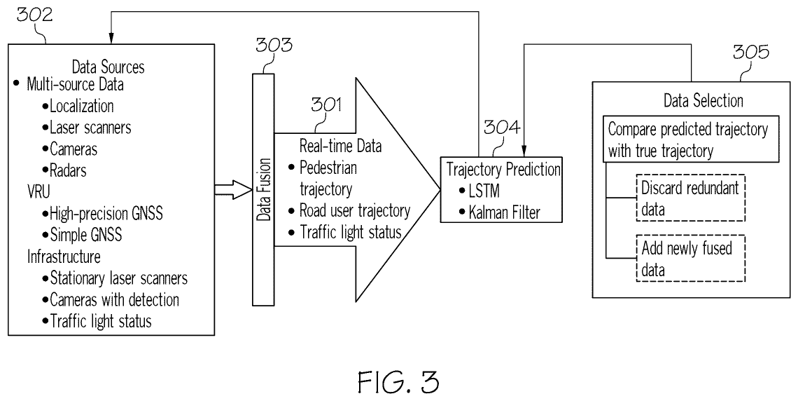

In one embodiment, different risk thresholds will be established, tailored to various types of road users and vehicles. FIG. 3 illustrates trajectory prediction using continual learning in accordance with an embodiment of the present disclosure.

Referring to FIG. 3, processing engine 201 processes real-time data 301 (e.g., pedestrian trajectory, road user trajectory, and traffic light status) obtained from data sources 302 captured from sensors (e.g., video cameras), road users' devices, and data from signal control. In one embodiment, such data sources 302 include multi-source data (e.g., localization, laser scanners, cameras, and radars), vulnerable road user (VRU) (e.g., high-precision global navigation satellite systems (GNSS), and simple GNSS), and infrastructure (e.g., stationary laser scanners, cameras with detection, and traffic light status).

In one embodiment, processing engine 201 applies data fusion techniques 303 to consolidate all the data, creating a baseline dataset for vehicles and road users. Afterwards, prediction engine 202 predicts trajectories 304 of the vehicle and road user movements based on the processed real-time data using machine learning approaches, such as Long Short-Term Memory (LSTM). In another embodiment, prediction engine 202 utilizes the Kalman filter for predicting trajectories 304.

In one embodiment, the system has the capability to improve its learning algorithm through a self-learning process 305, which includes comparing the predicted trajectory with the true trajectory. In one embodiment, redundant data many be discarded and new fused data may be added in self-learning process 305.

Furthermore, in one embodiment, analyzing engine 203 identifies a potential crash or an unsafe condition in response to the risk assessment for a detected vehicle movement or a road user movement exceeding a threshold value.

Computer 101 additionally includes warning engine 204 configured to generate a warning message or alert of an impending potential crash or unsafe condition in response to identifying the potential crash or the unsafe condition. In one embodiment, the warning message or alert is transmitted to a driver(s) and/or a vulnerable road user(s). In one embodiment, the warning message or alert is in the form of a text message, an audio message, or a visual message.

In one embodiment, warning engine 204 generates practical and feasible mitigation actions specific to the intersection scenario.

In this manner, embodiments of the present disclosure prevent collisions, such as between automobiles, between an automobile and a vulnerable road user and/or between vulnerable road users.

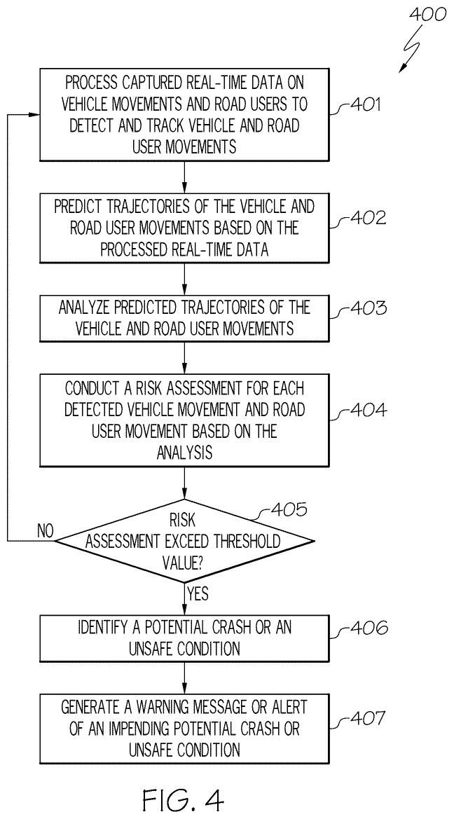

A further description of these and other features are discussed below in connection with FIGS. 4-6.

A discussion regarding the method for detecting potential crashes and unsafe conditions is provided below in connection with FIG. 4.

FIG. 4 is a flowchart of a method 400 for detecting potential crashes and unsafe conditions in accordance with an embodiment of the present disclosure.

Referring to FIG. 4, in conjunction with FIGS. 1-3, in step 401, processing engine 201 processes captured real-time data on vehicle movements and road users in order to detect and track vehicle and road user movements.

As stated above, in one embodiment, such real-time data is captured using high-resolution cameras/video systems, LiDAR, radar, and various other sensor technologies at key locations within targeted intersections. An intersection, as used herein, refers to the location where two or more roadways meet, cross, or join, forming a general area that includes the roadway and surrounding facilities to manage traffic movements.

In one embodiment, high-resolution cameras are utilized within an intersection to capture real-time data on vehicle movements and road users. In one embodiment, at least two cameras are installed to provide a comprehensive 360-degree view of the intersection. These cameras will operate continuously, capturing real-time data on the movements of vehicles and road users, offering a dynamic and detailed perspective of the intersection's activities. To ensure data accuracy, the raw information collected by the sensors will undergo a meticulous preprocessing stage performed by processing engine 201, aimed at filtering out noise and enhancing overall precision. Furthermore, in one embodiment, processing engine 201 implements data fusion techniques, integrating contextual information, such as speed limits, road infrastructure features (sidewalks, bike lanes, shoulders), and facility types. This integration approach will enable a more holistic understanding of the intersection's environment.

In one embodiment, processing engine 201 processes the captured real-time data using data fusion and long short-term memory techniques.

In one embodiment, processing engine 201 processes the captured real-time data using computer vision and machine learning algorithms.

In one embodiment, processing engine 201 uses a combination of techniques to detect and track vehicle and road user movements from real-time data.

In one embodiment, processing engine 201 preprocesses the raw data captured from various sensors, such as high-resolution cameras, LiDAR, and radar. In one embodiment, such preprocessing involves filtering out noise and enhancing the overall precision of the data.

After preprocessing, in one embodiment, processing engine 201 employs a multi-faceted approach, including computer vision and data fusion.

In one embodiment, processing engine 201 processes the captured real-time data using computer vision and machine learning for video analysis as discussed below.

In one embodiment, processing engine 201 processes real-time video feeds from high-resolution cameras using object detection and classification. In one embodiment, algorithms, such as YOLO (You Only Look Once) or R-CNN (Region-based Convolutional Neural Network), are trained on vast datasets of images and videos to identify and classify objects of interest (e.g., cars, trucks, buses, motorcycles, bicycles, pedestrians). In a real-time system, these models analyze each frame of the video feed to draw bounding boxes around detected objects.

Furthermore, in one embodiment, processing engine 201 processes real-time video feeds from high-resolution cameras using object tracking. Once objects are detected in a frame, tracking algorithms, such as the Kalman filter or SORT, link the same object across consecutive frames. This allows the system to determine the object's trajectory, speed, and other movement characteristics. For example, a car detected in one frame is identified as the same car in the next, allowing the system to follow its path through an intersection.

Additionally, in one embodiment, processing engine 201 performs behavioral analysis. The tracked data is then analyzed to understand a vehicle's or road user's behavior. This includes identifying turning movements, lane changes, accelerations, and decelerations thereby detecting traffic violations or predicting potential conflicts.

In one embodiment, processing engine 201 processes the captured real-time data using data fusion and contextual integration as discussed below.

In one embodiment, processing engine 201 processes the captured real-time data using sensor fusion. In one embodiment, data from different sensor types, such as cameras, LiDAR, and radar, are fused together. For example, a camera might provide a detailed visual representation, while LiDAR provides precise 3D depth and shape information, and radar offers reliable speed and distance measurements, particularly in poor weather conditions. This combination mitigates the weaknesses of individual sensors.

In one embodiment, processing engine 201 implements integration with contextual data. In one embodiment, processing engine 201 combines the processed sensor data with other relevant contextual information. Examples of such contextual information can include static data (road infrastructure features, such as speed limits, locations of sidewalks, and bike lanes) and dynamic data (real-time traffic information, such as congestion levels or incident reports from other sources).

Such fusion provides a richer understanding of the scene. For example, the system knows that a vehicle is on a bike lane and can flag it as a potential conflict, something that raw object detection alone might not recognize.

In step 402, prediction engine 202 predicts trajectories of the vehicle and road user movements based on the processed real-time data.

In one embodiment, prediction engine 202 utilizes algorithms tasked with detecting and tracking vehicles and road users enabling prediction engine 202 to predict their trajectories. These predictions will be based on a combination of historical movement patterns, real-time data, and contextual information.

In one embodiment, prediction engine 202 predicts trajectories of the vehicle and road user movements based on the processed real-time data using a combination of machine learning algorithms, deep learning models, and real-time data integration. In one embodiment, a model is trained on historical data to recognize patterns. In one embodiment, prediction engine 202 uses the trained model to predict future movements based on real-time data and contextual information.

In one embodiment, such a model is trained using real-time data, historical data, and contextual information.

In one embodiment, historical data includes large datasets of past movements and trajectories, which are used to train the model. In one embodiment, such data includes information about object movements, timestamps, and environmental conditions.

Iu one embodiment, contextual information includes data that describes the environment, such as speed limits, traffic signal status, road layout (e.g., lanes, sidewalks, crosswalks), and weather conditions.

In one embodiment, prediction engine 202 uses one or more types of prediction models to be trained using the data discussed above to predict trajectories of the vehicle and road user movements based on the processed real-time data.

In one embodiment, prediction engine 202 utilizes long short-term memory (LSTM) networks. In one embodiment, prediction engine 202 uses LSTMs to learn from a sequence of past positions and movements to predict the next position in the sequence.

In one embodiment, prediction engine 202 utilizes transformer models. In one embodiment, such models use “attention mechanisms” to weigh the importance of different data points in the history of a trajectory, providing highly accurate predictions.

In one embodiment, prediction engine 202 utilizes generative models, such as generative adversarial networks (GANs), to generate a variety of possible future trajectories, each with a probability score, which is useful for handling the inherent uncertainty of predicting human and vehicle behavior.

In one embodiment, prediction engine 202 utilizes hybrid models, such as a deep learning model combined with a physics-based or kinematic motion model to improve the realism of predictions. The deep learning component predicts attributes, such as acceleration and yaw rate, which are then used by the kinematic model to generate a physically feasible trajectory.

In one embodiment, prediction engine 202 trains the model to predict the trajectories of the vehicle and road user movements.

In one embodiment, prediction engine 202 feeds the model a sequence of historical data points for a specific object (e.g., a vehicle's position and velocity over the last few seconds). The model also ingests contextual data about the environment.

In one embodiment, the model learns the typical movement patterns associated with different scenarios (e.g., a car slowing down at a red light, a pedestrian crossing at a crosswalk, or a vehicle turning left).

In one embodiment, when new, real-time data comes in from processing engine 201, prediction engine 202 uses its trained model to forecast the object's trajectory over a future time horizon (e.g., the next 3-5 seconds).

In one embodiment, the output of the model is a series of predicted future locations (e.g., a path or trajectory), often with an associated probability or confidence score for each possible path. In one embodiment, such an output enables prediction engine 202 to not only know where an object is likely to go but also to assess the risk of different potential movements.

In one embodiment, prediction engine 202 performs movement prediction. In one embodiment, prediction engine 202 uses LSTMs to analyze the historical movement patterns of a vehicle or road user to predict their future trajectory. For instance, by observing a car's turn signal and its movement pattern over the last few seconds, an LSTM model can predict with high accuracy whether it will turn left or continue straight.

By learning normal traffic patterns at an intersection, an LSTM can identify anomalous or dangerous movements, such as a vehicle suddenly changing lanes or a pedestrian stepping into the road unexpectedly, which enables automated alerts or proactive safety measures.

In step 403, analyzing engine 203 analyzes the predicted trajectories of the vehicle and road user movements.

As stated above, analyzing engine 203 is configured to analyze the predicted trajectories of the vehicle and road user movements based on the processed real-time data. In one embodiment, the analysis of the predicted trajectories of the vehicle and road user movements includes analyzing vehicular speed, pedestrian walking pace and walking patterns, turning maneuvers, and turning intentions.

In one embodiment, in real-time, analyzing engine 203 performs dynamic analyses of the trajectories it detects, actively identifying potential conflicts or unsafe conditions. This analysis will consider various scenarios, accommodating both road users who adhere to intersection control signals and those who deviate from prescribed rules. Moreover, the trajectory prediction process will encompass a range of critical factors, including the speed of vehicles, the walking pace of pedestrians, pedestrian walking patterns, recognition of turning maneuvers, and the determination of turning intentions. Drawing from this comprehensive trajectory prediction, the system will generate numeric measures, such as gap analysis, potential conflict assessment, and time-to-crash calculations.

In one embodiment, such an analysis involves calculating specific safety metrics and assessing various movement attributes for both vehicles and road users.

In one embodiment, analyzing engine 203 analyzes vehicular and pedestrian movements. In one embodiment, such an analysis involves taking the predicted trajectories and extracting key attributes for analysis.

In one embodiment, the instantaneous and average speed of vehicles and the walking pace of pedestrians are calculated based on the predicted trajectory data (change in position over time). Such calculations are used to identify excessively fast vehicles or unusually slow movements.

In one embodiment, analyzing engine 203 analyzes the predicted path to identify turning maneuvers. In one embodiment, analyzing engine 203 performs geometric analysis of the trajectory's curvature or applies a classification model that predicts turning intentions based on a combination of a vehicle's historical path, its use of turn signals (if available from vision data), and its position relative to the intersection lanes.

In one embodiment, analyzing engine 203 performs conflict and safety analysis in order to asses risks by calculating specific metrics.

In one embodiment, analyzing engine 203 performs gap analysis, which measures the distance or time gap between two objects. For example, analyzing engine 203 calculates the gap between a turning vehicle and an oncoming vehicle, or between a vehicle and a pedestrian crossing its path, where a small gap indicates a high-risk situation.

In one embodiment, analyzing engine 203 performs time-to-collision (TTC) analysis. In one embodiment, TTC is utilized as a metric for collision avoidance. It is the time it would take for two objects to collide if they maintain their current speed and direction. The formula is:

$$TTC = \frac{Distance between objects}{Relative speed}$$

A low TTC value (e.g., less than 2-3 seconds) signals an imminent collision risk.

In one embodiment, analyzing engine 203 performs a potential conflict assessment which involves analyzing predicted trajectories of all road users within an area to identify points where their paths are likely to intersect. Analyzing engine 203 can then assess the severity of the conflict based on factors, such as speed, object types (e.g., a car vs. a bicycle), and the TTC at the point of intersection. In one embodiment, analyzing engine 203 accommodates scenarios where road users deviate from prescribed rules, such as a pedestrian jaywalking or a vehicle running a red light.

In step 404, analyzing engine 203 conducts a risk assessment for each detected vehicle movement and road user movement based on the analysis of the predicted trajectories of the vehicle and road user movements.

As discussed above, to identify potential crashes or unsafe conditions, in one embodiment, analyzing engine 203 conducts a thorough risk assessment for each detected movement. This assessment will encompass scenarios where road users strictly adhere to intersection control directions as well as situations where deviations occur.

In one embodiment, analyzing engine 203 conducts a risk assessment for each detected vehicle movement and road user movement based on the analysis of the predicted trajectories of the vehicle and road user movements by assigning a quantifiable risk score to each movement. In one embodiment, such a process goes beyond simply detecting a potential conflict. Such a process involves weighing the severity and probability of a crash.

In one embodiment, analyzing engine 203 defines risk metrics. Risk is a function of both the probability and severity of a potential crash. In one embodiment, analyzing engine 203 translates its analysis of predicted trajectories into the metrics of probability and severity.

In one embodiment, analyzing engine 203 derives the probability metric from the analysis of trajectories. A higher probability of conflict exists when the Time-to-Collision (TTC) is very low, when the post-encroachment time (PET), which is the time between one object clearing a conflict zone and a second object entering it, is low, when the trajectories of multiple objects converge at the same point simultaneously, and when a road user is predicted to deviate from expected behavior (e.g., running a red light or jaywalking), which increases the likelihood of a conflict with other, rule-abiding road users.

In one embodiment, analyzing engine 203 derives the severity metric (refers to the potential consequences of a crash) based on factors, such as speed (e.g., higher speeds lead to more severe impacts), type of object (e.g., a collision between a large truck and a pedestrian is far more severe than one between two bicycles), and angle of impact (e.g., a head-on or T-bone collision is generally more severe than a side-swipe).

In one embodiment, analyzing engine 203 uses a risk score algorithm, which combines the probability and severity metrics to generate a single, quantifiable risk score for each movement. In one embodiment, analyzing engine 203 generates such a single, quantifiable risk score for each movement using a weighted formula or a machine learning model.

In one embodiment, analyzing engine 203 computes the risk score using the weighted formula

$$Risk Score = {w}_{1} \cdot \frac{1}{TTC} + {w}_{2} \cdot \frac{1}{PET} + {w}_{3} \cdot Speed + {w}_{4} \cdot Impact Angle + ⋯$$

where the weights (w1,w2,w3, . . . ) are adjusted based on the relative importance of each factor.

In one embodiment, analyzing engine 203 uses a machine learning model to generate such a single, quantifiable risk score for each movement. In one embodiment, a supervised machine learning model (e.g., a random forest or a neural network) is trained on a dataset of historical traffic events labeled with their outcomes (e.g., “safe,” “near-miss,” “crash”). The model then takes as input the calculated TTC, PET, speed, object types, and other factors and outputs a risk score.

In one embodiment, analyzing engine 203 handles various scenarios, including deviating scenarios, which can be predicted before such deviations occur.

In one embodiment, analyzing engine 203 performs an analysis based on adherence to rules. For example, the risk assessment for a vehicle following traffic signals may focus on interactions with other compliant vehicles or with unexpected anomalies (e.g., an animal on the road).

In another embodiment, analyzing engine 203 performs an analysis based on deviations from rules. For example, analyzing engine 203 actively looks for and assigns high risk to movements that violate traffic laws or typical behavior. For example, a vehicle that is predicted to enter an intersection after its light has turned red is a predicted high risk movement. In another example, a pedestrian that is predicted to cross a road outside of a designated crosswalk is a predicted high risk movement.

In these cases, the risk score is automatically elevated due to the increased probability of conflict, regardless of initial speed or other factors.

In step 405, a determination is made by analyzing engine 203 as to whether the risk assessment (i.e., the risk score) for a detected vehicle movement or a road user movement exceeds a threshold value, which may be user-designated.

If the risk assessment (i.e., the risk score) for a detected vehicle movement or a road user movement does not exceed the threshold value, then processing engine 201 processes newly captured real-time data on vehicle movements and road users in order to detect and track vehicle and road user movements in step 401.

If, however, the risk assessment (i.e., the risk score) for a detected vehicle movement or a road user movement exceeds the threshold value, then, in step 406, analyzing engine 203 identifies a potential crash or an unsafe condition.

In one embodiment, analyzing engine 203 identifies a potential crash or unsafe condition using a pre-defined risk threshold. When the calculated risk score (e.g., the single, quantifiable risk score discussed above) for a vehicle or road user movement exceeds this threshold value, analyzing engine 203 flags the situation as high-risk, triggering a response.

In one embodiment, the risk threshold is a numerical value that represents the dividing line between an acceptable risk and an unacceptable one.

In one embodiment, the risk threshold is dynamic. For example, it could be lower during adverse weather conditions (rain, fog) or in areas with vulnerable road users, such as school zones.

In one embodiment, analyzing engine 203 compares each new risk score (e.g., the single, quantifiable risk score discussed above) against the predefined threshold value. If the risk score exceeds the threshold value, then analyzing engine 203 identifies a potential crash or unsafe condition. If, however, the risk score is less than or equal to the threshold value, then the movement is considered within acceptable risk levels, and no immediate action is taken, though the system continues to monitor.

In one embodiment, once a risk score exceeds the threshold, the system triggers an action as discussed below.

In step 407, warning engine 204 generates a warning message or alert of an impending potential crash or unsafe condition in response to identifying the potential crash or unsafe condition.

As discussed above, in one embodiment, the warning message or alert is transmitted to a driver(s) and/or a vulnerable road user(s). In one embodiment, the warning message or alert is in the form of a text message, an audio message, or a visual message.

In one embodiment, warning engine 204 generates practical and feasible mitigation actions specific to the intersection scenario.

In one embodiment, warning engine 204 triggers a warning message or alert when analyzing engine 203 identifies a potential crash or unsafe condition (i.e., when the risk score exceeds the defined threshold). In one embodiment, the warning message/alert is immediate, clear and concise (e.g., “pedestrian in roadway ahead,” “potential collision with turning vehicle”), and contextual (e.g., warning/alert includes relevant details, such as the location of the threat).

In one embodiment, warning engine 204 presents the warning/alert in multiple forms. In one embodiment, such a warning/alert is a visual message, such as being displayed on a vehicle's dashboard screen, a smartphone app, or a smart traffic sign.

In one embodiment, such a warning/alert is an audio message, such as a voice alert or a distinct sound played inside a vehicle or on a mobile device.

In one embodiment, such a warning/alert is a text message, such as a short, quick text alert for systems that support it.

In one embodiment, warning engine 204 transmits the warning/alert to the appropriate recipient. In one embodiment, warning engine 204 transmits the warning/alert using the vehicle-to-infrastructure (V2I)/infrastructure-to-vehicle (I2V) communication protocol. In such an embodiment, warning engine 204 communicates with connected vehicles via cellular networks (5G) or dedicated short-range communication (DSRC). In one embodiment, the warning/alert is sent directly to the vehicle's onboard system, which can then display the warning to the driver.

In another embodiment, warning engine 204 transmits the warning/alert using the infrastructure-to-pedestrian (I2P) communication protocol. In one embodiment, warning engine 204 transmits warnings/alerts to vulnerable road users (pedestrians, cyclists) via their smartphones, smartwatches, or other connected devices, such as via a mobile application.

In one embodiment, such a warning/alert includes mitigating actions. That is, the warning/alert provides specific, actionable advice to help prevent the crash.

For example, for drivers, warning engine 204 might recommend specific actions, such as “Brake now,” “Prepare to stop,” or “Yield to pedestrian.” It could also indicate the direction of the threat, e.g., “Left-side collision risk.”

In another example, for vulnerable road users, the warning might tell a pedestrian to “Stop, don't cross,” or “Wait for green signal.”’

In one embodiment, such actions are determined by warning engine 204 based on performing a look-up in a data structure (e.g., table) containing an action for each identified potential crash or unsafe condition. In one embodiment, such a data structure is populated by a traffic and safety engineer, a data analyst, a machine learning specialist, urban planner, etc. In one embodiment, such a data structure resides within the storage device (e.g., storage device 113, 115) of computer 101.

Additional details regarding further embodiments of the framework of BLISS detecting potential crashes and unsafe conditions is provided below.

### Risk-Assessment

To integrate the risk assessment component in the BLISS framework, computer 101 considers the following key aspects.

Historical Crash Data: The framework utilizes historical crash data as a valuable resource for comprehending past intersection-related crashes, encompassing details about crash types, severity patterns, and contributing factors.

Traffic Volume: Recognizing that high traffic volumes can lead to congestion and an increased likelihood of crashes, the analysis of traffic data becomes pivotal. This analysis aids in identifying intersections with substantial traffic flow, potentially making them candidates for BLISS implementation.

Multi-Source Data: The data insights for the intersections are developed from multi-source data (e.g., demographic data, economic data, crowd-sourced data) and advanced data fusion.

Prioritization: Building on the findings from the risk assessment, the framework prioritizes intersections exhibiting the highest risk levels for BLISS implementation.

### Sensing and Perception

The BLISS framework entails the integration of advanced sensors and computer vision technologies to perform precise real-time detection, localization, and classification of multiple individual vehicles and VRUs. In one embodiment, such a goal is realized through the strategic deployment of high-resolution cameras, LiDAR, radar, and various other sensor technologies at key locations within the targeted intersections.

The merits and drawbacks of these sensor technologies have been comprehensively analyzed previously. When assessing sensor technologies for applications, such as pedestrian detection and road user monitoring, an evaluation of their strengths and weaknesses becomes imperative. In one embodiment, BLISS focuses on three primary sensor types: LiDAR, Radar, and Camera/Video systems.

### Vehicle and Road User Movement Prediction

In one embodiment, different risk thresholds are established, tailored to various types of road users and vehicles. First, BLISS utilizes data from sensors (e.g., video cameras), road users' devices, and data from signal control. In one embodiment, BLISS applies data fusion techniques to consolidate all the data, creating a baseline dataset for vehicles and road users. Afterwards, trajectory prediction is generated using machine learning approaches, such as Long Short-Term Memory (LSTM). Finally, the system has the capability to improve its learning algorithm through a self-learning process.

In response to these calculations, in one embodiment, BLISS promptly generates warning messages designed to proactively alert relevant parties to impending risks or hazards. The system also generates practical and feasible mitigation actions specific to the intersection scenario. Furthermore, in one embodiment, BLISS continually learns and adapts through feedback loops and regular updates. This adaptive process will refine the system's predictive models and mitigation strategies based on real-world performance and the evolving patterns of traffic flow. To ensure the reliability and accuracy of BLISS in predicting movements, identifying risks, and executing mitigation strategies effectively, rigorous testing and validation procedures are carried out.

### Data Handling and Storage

In one embodiment, BLISS at each intersection processes a substantial volume of data generated by high-resolution cameras strategically positioned at the intersection. For instance, a single high-definition camera can produce approximately 100 MB of data per minute. With multiple cameras operating simultaneously, data volume can reach several gigabytes per hour. High-bandwidth connections, with capacities exceeding 100 Mbps, will ensure smooth data transmission from cameras to the central processing unit. In one embodiment, the system manages various types of data, primarily images and video streams, alongside corresponding metadata capturing timestamps, location information, and sensor status. Local storage solutions provide real-time accessibility to critical data. In one embodiment, BLISS utilizes high-capacity solid-state drives (SSDs) to accommodate the constant inflow of data. In one embodiment, each camera has local storage capacity to retain up to 48 hours of data for immediate analysis and crash response. In one embodiment, cloud-based storage is employed for archiving historical data. In one embodiment, BLISS utilizes cloud providers with scalable storage solutions, allowing the system to store and retrieve data efficiently over extended periods. Data retention policies will dictate the archiving duration. For instance, the system may retain historical data for a period of 30 days, providing ample time for post-crash analysis and research while adhering to privacy regulations.

To protect privacy, in one embodiment, BLISS implements advanced anonymization techniques. These will include pixelation or blurring of faces and license plates within the images and videos. Privacy policies will ensure strict adherence to legal and ethical standards regarding data collection and usage, specifying the types of data that will be anonymized and retained. In one embodiment, BLISS incorporates cybersecurity measures. Data transmissions are encrypted to protect against interception, and access controls will restrict data access to authorized personnel only. Intrusion detection systems and regular security audits will continuously monitor and fortify the system's defenses against potential cyber threats.

### Wireless Communications and Positioning

In one embodiment, BLISS incorporates cutting-edge wireless communications and positioning technologies to enhance its operational capabilities. In one embodiment, the system of the present disclosure includes the following communication options.

5G Connectivity: BLISS capitalizes on 5G technology to ensure lightning-fast data transfer, with speeds of up to 10 Gbps and latency as low as 1 millisecond.

Wi-Fi: Wi-Fi connectivity is employed for short-range data exchange within the intersection, providing reliable communication within a range of approximately 100 meters.

Bluetooth: Bluetooth technology, specifically Bluetooth Low Energy (BLE), is utilized for proximity-based data transfer.

Dedicated Short-Range Communication (DSRC): Integrated DSRC technology provides short-range wireless communication specifically designed for vehicular use, with a communication range of approximately 300 meters. It will enable fast and reliable data exchange within this limited range, contributing to enhanced safety and situational awareness at intersections. DSRC is used for both vehicle-to-infrastructure (V2I) and vehicle-to-everything (V2X) communication.

All the above-mentioned technologies may not be considered for every BLISS. In one embodiment, the adoption is selected based on the specific intersection's needs and the cost of implementation. BLISS incorporates infrastructure-based positioning through the utilization of GPS technology. This ensures precise geospatial referencing, with GPS accuracy typically within a range of 1 to 5 meters. GPS-enabled infrastructure guarantees that all data, including vehicle and road user positions, aligns with real-world coordinates, providing BLISS with accurate location information for effective crash detection and response. In addition, in one embodiment, Roadside Units (RSUs), equipped with Bluetooth and Wi-Fi capabilities, are strategically positioned within the intersection to support wireless communication and data exchange. These RSUs serve as communication hubs, facilitating data transmission between various components of BLISS. RSUs provide coverage within a radius of up to 500 meters, ensuring reliable communication with cameras, sensors, and other BLISS elements.

### Intersection Control System Interaction

In one embodiment, BLISS establishes real-time interconnections, ensuring swift data exchange and responsiveness, while adhering to industry standards and protocols for future compatibility. BLISS specifies complementary actions tailored to different road user classes, harmonizing with existing control mechanism, such as traffic signals, dynamic signage, and indicators. Roadside infrastructure will facilitate secure interconnections, ensuring reliable data exchange via signal cabinets and connections to the central traffic management system through wireless or fiber optic links. This interaction will empower control systems to optimize traffic signal timings, signage, and indicators, and BLISS employs adaptive responses to anticipate conflicts and proactively mitigate risks, setting new standards for intersection safety and efficiency. Table 1, shown below, provides examples of relevant industry standards to which BLISS adheres.

TABLE 1
ISS Relevant Industry Standards

| Source | # | Name | Purpose |
|---|---|---|---|
| Society of | J2945/9 | Vulnerable | Ensures basic |
| Automotive | | Road User | safety message |
| Engineers | | Safety | standards between |
| (SAE) | | Message | a Vulnerable Road |
| | | Minimum | User and a |
| | | Performance | vehicle. |
| | | Requirements | |
| Institute of | 1609 family | Standards | Outlines the |
| Electrical and | | for Wireless | structure, |
| Electronics | | Access in | communication |
| Engineers | | Vehicular | methods, management |
| (IEEE) | | Environments | system, security |
| | | (WAVE) | measures, and |
| | | | physical access |
| | | | for wireless |
| | | | communications |
| | | | in vehicles. |
| National | 1218 | Object | Describes how |
| Transportation | | Definitions | a management |
| Communications | | for Roadside | station connects |
| for Intelligent | | Units | with a roadside |
| Transportation | | | unit, including |
| System Protocol | | | sending and |
| (NTCIP) | | | receiving Radio |
| | | | Technical |
| | | | Commission for |
| | | | Maritime |
| | | | Services (RTCM) |
| | | | GPS correction |
| | | | messages. |
| International | 26262 | Road vehicles - | Sets the standards |
| Organization | | Functional | for functional |
| for | | Safety | safety in |
| Standardization | | | automotive equipment, |
| (ISO) | | | covering the |
| | | | entire lifecycle |
| | | | of all electronic |
| | | | and electrical |
| | | | safety-related |
| | | | systems. |

### Warning System

In one embodiment, BLISS incorporates a comprehensive warning system designed to enhance the safety of both vulnerable road users and vehicles. In one embodiment, this system offers multiple alarm types, ensuring alerts are accessible and effective in diverse scenarios. These notifications may include warnings transmitted to wirelessly connected vehicles, ensuring all road users, including those without wireless connectivity, receive timely alerts. One of the key priorities of the warning system is accessibility. In one embodiment, BLISS is equipped to alert vulnerable road users who may have visual or hearing impairments, thus ensuring inclusivity and compliance with the Americans with Disabilities Act (ADA). Personal devices are more practical for delivering alerts due to their cost-effectiveness and functionality, especially with the widespread use of smartphones today. However, the challenge is ensuring the alert is specific to the user. If the VRU does not register their device with the infrastructure, it can be hard to send targeted warnings. On the other hand, a stationary alert device in the infrastructure would be highly visible but not user specific. Therefore, in one embodiment, BLISS adopts a multilayer warning system. First, the system attempts to establish connections with users' smartphones and involved vehicles to deliver warning messages. These messages will also trigger haptic vibrations. However, if BLISS cannot establish connections with the users, it will provide audio and visual warnings from an external source.

### Interoperability and Extensibility Considerations

In one embodiment, BLISS incorporates interoperability and extensibility at its core, ensuring a harmonious integration with existing intersection infrastructure without compromising safety. This commitment includes facilitating collaboration with neighboring intersections equipped with BLISS and adhering to industry standards, fostering a collaborative safety ecosystem. In one embodiment, BLISS features modular hardware and software designs to facilitate future upgrades and expansions, adapting to evolving safety technologies.

### Event Reporting

In one embodiment, BLISS incorporates robust event reporting capabilities to facilitate performance measurement and continuous system enhancement. In one embodiment, the framework considers the following:

Comprehensive Event Logging: BLISS maintains an extensive event log, capturing data on actual crashes and near-miss occurrences.

Tagging and Categorization: Each recorded event is tagged and categorized to support detailed retrospective analyses. Tags include information related to the nature of the event, involved road users, environmental conditions, and system responses.

Unintended Consequences: BLISS tracks unintended consequences of safety interventions, helping identify and rectify any unexpected outcomes. This proactive approach ensures that safety enhancements do not inadvertently introduce new risks.

Site-Specific Tailoring: To optimize safety measures, the event reporting system supports site-specific tailoring. By analyzing event data in the context of specific intersection characteristics, BLISS tailors its responses to better align with the unique requirements of each location.

Continuous Improvement: The data collected through event reporting serves as a valuable resource for the continuous improvement of BLISS. By identifying patterns, trends, and areas of concern, the system evolves to provide even greater safety and efficiency benefits.

In one embodiment, BLISS features a multifaceted wireless communication system, including Bluetooth and DSRC, to enable seamless data exchange with road users, vehicles, and the central traffic management system. Real-time integration with existing intersection control systems optimizes traffic signal timings, signage, and indicators. A comprehensive warning system provides audible alarms, visual alerts, haptic feedback, and real-time notifications to vulnerable road users and vehicles. In one embodiment, BLISS implements a multilayered warning system. Initially, the system attempts to connect with users' smartphones and involved vehicles to deliver warnings. If connections cannot be established, audio and visual warnings are triggered from an external source. To detect potentially hazardous situations and generate appropriate warnings, the videos captured by the cameras are analyzed. The following provides an example of how the warning system functions for a distracted pedestrian.

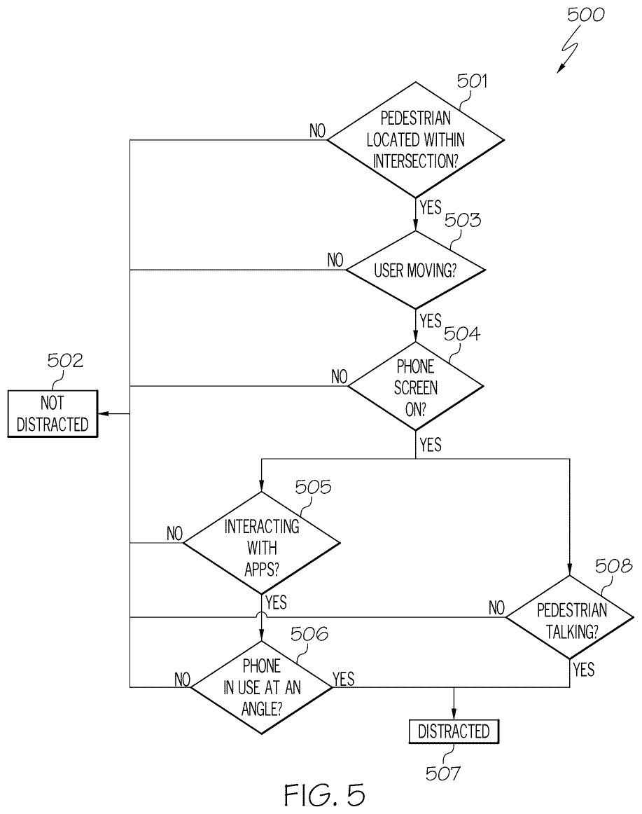

First, based on the camera feeds, BLISS assesses whether pedestrians are distracted using specific criteria outlined in FIG. 5.

FIG. 5 is a flowchart of a method 500 for pedestrian distraction detection in accordance with an embodiment of the present disclosure.

Referring to FIG. 5, a determination is made in step 501, such as by analyzing engine 203, as to whether the user (pedestrian) is located within an intersection. If the user (pedestrian) is not located within the intersection, then the pedestrian is not distracted (see step 502). If, however, the user (pedestrian) is located within the intersection, then analyzing engine 203 determines whether the user (pedestrian) is moving in step 503. If the user is not moving, then the pedestrian is not distracted (see step 502).

If, however, the user (pedestrian) is moving, then, in step 504, analyzing engine 203 determines whether the phone screen is on. If the phone screen is not on, then the pedestrian is not distracted (see step 502).

If, however, the phone screen is on, then, in step 505, analyzing engine 203 determines if the user (pedestrian) is interacting with apps. If the user (pedestrian) is not interacting with apps, then the pedestrian is not distracted (see step 502).

If, however, the user (pedestrian) is interacting with apps, then, in step 506, analyzing engine 203 determines if the phone in use is at an angle.

If the phone in use is not at an angle, then the pedestrian is not distracted (see step 502).

If, however, the phone in use is at an angle, then, in step 507, analyzing engine 203 determines that the pedestrian is distracted.

As an alternative to step 505, in step 508, analyzing engine 203 determines whether the user (pedestrian) is talking.

If the user (pedestrian) is not talking, then the pedestrian is not distracted (see step 502).

If, however, the user (pedestrian) is talking, then analyzing engine 203 determines that the pedestrian is distracted in step 507.

If a distracted pedestrian is detected and a hazardous situation is possible, then warning engine 204 sends warning messages, such as via Bluetooth.

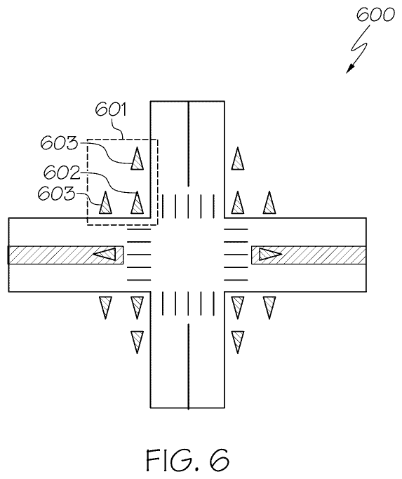

In one embodiment, Bluetooth beacons will establish communication, with three beacons installed at each corner, as illustrated in FIG. 6.

FIG. 6 illustrates beacon layout 600 in accordance with an embodiment of the present disclosure.

As shown in FIG. 6, users, located within region 601, receive an alert from a central/main beacon 602 and/or supporting beacons 603.

In one embodiment, central beacon 602 has an 8-meter radius, triggering an alert if pedestrians enter this region (e.g., region 601). In one embodiment, supporting beacons 603 within a 20-meter radius activate the system. In one embodiment, the radius is adjusted based on prototype performance. For vehicles, DSRC is used to provide alerts. If a vehicle lacks DSRC communication, visual warnings are displayed using four LED-based Dynamic Message Signs (DMS) at each corner of the intersection. It is noted that visual feedback is only activated if Bluetooth and DSRC communications fail. While FIG. 6 is discussed in connection with region 601, it is noted that beacon layout 600 may include many similar regions as region 601 that contain beacons 602, 603.

In one embodiment, BLISS is equipped with onboard SSDs with a minimum capacity of 10 TB, allowing temporary data storage for at least 48 hours before transmission and redundancy. To handle the substantial data generated, BLISS utilizes cloud-based storage solutions. In one embodiment, BLISS utilizes Microsoft® Azure® with an 80 TB storage capacity. In one embodiment, BLISS maintains a comprehensive event log, capturing data on crashes and near-miss crashes. Events are detected through machine vision techniques and trajectory analysis. In one embodiment, in a crash, BLISS automatically sends messages, including screenshots of the actual crash, to emergency responders, such as the police and fire service, using cellular 5G connectivity.

In the embodiments discussed herein, BLISS incorporates an anticipatory warning system, as well as other safety countermeasures designed to address the safety of both drivers, and VRU, with primary application at high-risk intersections nationwide. In one embodiment, the BLISS framework/tool integrates advanced sensors and computer vision technologies, and high-resolution cameras/video systems (e.g., LiDAR, and/or radar), which will allow for the real-time detection, localization, and classification of multiple vehicles and VRU. In one embodiment, the various sensors/devices are deployed at key locations within a given, high-risk intersection.

In one embodiment, a camera-based system is used for BLISS, with the option of incorporating LiDAR and radar devices. In one embodiment, at least two high resolution cameras are connected as a network and provide a 360° view of an intersection and will continuously capture real-time data (e.g., photos, videos, etc.) on vehicle movements and road users. Once acquired, data is processed using computer vision and machine learning algorithms to detect and track vehicle/road user movements for use in predicting their trajectories for the identification of potential conflicts/unsafe conditions. In one embodiment, the trajectory prediction process/algorithms evaluate a variety of factors, such as vehicular speed, pedestrian walking pace and walking patterns, identification of turning maneuvers, and turning intentions. In one embodiment, collected/processed data is used to conduct a risk assessment for each detected motion to identify potential crashes/unsafe conditions. In one embodiment, data is evaluated by the system using both data fusion as well as Long Short-Term Memory (LSTM) techniques. Based on these results, BLISS generates warning messages/alerts designed to alert parties, such as drivers, pedestrians/VRU, of impending risks/hazards specific to a given intersection in real-time. Alarms/warnings may include a variety of types, such as warnings transmitted to wirelessly connected vehicles, warnings transmitted to VRUs who may have visual/hearing impairments, warnings (e.g., text messages, vibrations) transmitted to drivers/pedestrians' smart phones, and/or visual/audio warnings generated by an external source. If an actual collision occurs, BLISS is designed to automatically send messages, including crash screenshots, to emergency responders via cellular 5G connectivity.

In one embodiment, BLISS continually learns and adapts through feedback loops and regular software updates to more effectively identify potential hazards/generate warning messages. In one embodiment, the use of wireless communication/positioning technology is integrated into the system in varying degrees depending on the situation including one or more of the following: 5G, GPS, Wi-Fi, Bluetooth, DSRC. In one embodiment, BLISS includes an event reporting system for use in measuring/evaluating the performance of the system and achieving continuous system improvements. To protect privacy, BLISS uses anonymization techniques, e.g., pixelation, blurring of faces/license plates within the captured images and videos.

As a result of the foregoing, embodiments of the present disclosure provide a means for preventing collisions, such as between automobiles, between an automobile and a vulnerable road user and/or between vulnerable road users.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for detecting potential crashes and unsafe conditions, the method comprising:
processing captured real-time data on vehicle movements and road users to detect and track vehicle and road user movements;
predicting trajectories of said vehicle and road user movements based on said processed real-time data;
analyzing said predicted trajectories of said vehicle and road user movements;
conducting a risk assessment for each detected vehicle movement and road user movement based on said analysis of said predicted trajectories of said vehicle and road user movements;
identifying a potential crash or an unsafe condition in response to said risk assessment for a detected vehicle movement or a road user movement exceeding a threshold value; and
generating a warning message or alert of an impending potential crash or unsafe condition in response to identifying said potential crash or said unsafe condition.

2. The method as recited in claim 1, wherein said analysis of said predicted trajectories of said vehicle and road user movements comprises analyzing vehicular speed, pedestrian walking pace and walking patterns, turning maneuvers, and turning intentions.

3. The method as recited in claim 1, wherein said captured real-time data is processed using data fusion and long short-term memory techniques.

4. The method as recited in claim 1, wherein said captured real-time data is processed using computer vision and machine learning algorithms.

5. The method as recited in claim 1, wherein said real-time data is captured at a road intersection using high resolution cameras.

6. The method as recited in claim 1, wherein said warning message or said alert is transmitted to one or more drivers and/or one or more vulnerable road users.

7. The method as recited in claim 1, wherein said warning message or said alert is in a form of a text message, a vibration, an audio message, or a visual message.

8. A computer program product for detecting potential crashes and unsafe conditions, the computer program product comprising one or more computer readable storage mediums having program code embodied therewith, the program code comprising programming instructions for:
processing captured real-time data on vehicle movements and road users to detect and track vehicle and road user movements;
predicting trajectories of said vehicle and road user movements based on said processed real-time data;
analyzing said predicted trajectories of said vehicle and road user movements;
conducting a risk assessment for each detected vehicle movement and road user movement based on said analysis of said predicted trajectories of said vehicle and road user movements;
identifying a potential crash or an unsafe condition in response to said risk assessment for a detected vehicle movement or a road user movement exceeding a threshold value; and
generating a warning message or alert of an impending potential crash or unsafe condition in response to identifying said potential crash or said unsafe condition.

9. The computer program product as recited in claim 8, wherein said analysis of said predicted trajectories of said vehicle and road user movements comprises analyzing vehicular speed, pedestrian walking pace and walking patterns, turning maneuvers, and turning intentions.

10. The computer program product as recited in claim 8, wherein said captured real-time data is processed using data fusion and long short-term memory techniques.

11. The computer program product as recited in claim 8, wherein said captured real-time data is processed using computer vision and machine learning algorithms.

12. The computer program product as recited in claim 8, wherein said real-time data is captured at a road intersection using high resolution cameras.

13. The computer program product as recited in claim 8, wherein said warning message or said alert is transmitted to one or more drivers and/or one or more vulnerable road users.

14. The computer program product as recited in claim 8, wherein said warning message or said alert is in a form of a text message, a vibration, an audio message, or a visual message.

15. A system, comprising:
a memory for storing a computer program for detecting potential crashes and unsafe conditions; and
a processor connected to the memory, wherein the processor is configured to execute program instructions of the computer program comprising:
processing captured real-time data on vehicle movements and road users to detect and track vehicle and road user movements;
predicting trajectories of said vehicle and road user movements based on said processed real-time data;
analyzing said predicted trajectories of said vehicle and road user movements;
conducting a risk assessment for each detected vehicle movement and road user 11 movement based on said analysis of said predicted trajectories of said vehicle and road user movements;
identifying a potential crash or an unsafe condition in response to said risk assessment for a detected vehicle movement or a road user movement exceeding a threshold value; and
generating a warning message or alert of an impending potential crash or unsafe condition in response to identifying said potential crash or said unsafe condition.

16. The system as recited in claim 15, wherein said analysis of said predicted trajectories of said vehicle and road user movements comprises analyzing vehicular speed, pedestrian walking pace and walking patterns, turning maneuvers, and turning intentions.

17. The system as recited in claim 15, wherein said captured real-time data is processed using data fusion and long short-term memory techniques.

18. The system as recited in claim 15, wherein said captured real-time data is processed using computer vision and machine learning algorithms.

19. The system as recited in claim 15, wherein said real-time data is captured at a road intersection using high resolution cameras.

20. The system as recited in claim 15, wherein said warning message or said alert is transmitted to one or more drivers and/or one or more vulnerable road users.
